(19) United States
(12) Patent Application Publication
(10) Pub. No.: US 2018/0097865 A1
(43) Pub. Date: Apr. 5, 2018

(54) VIDEO PROCESSING APPARATUS AND METHOD

(71) Applicant: TwoEyes Tech, Inc., Anyang-si (KR)

(72) Inventor: Hun Joo SONG, Yongin-si (KR)

(21) Appl. No.: 15/333,972

(22) Filed: Oct. 25, 2016

(30) Foreign Application Priority Data
Oct. 4, 2016 (KR) 10-2016-0127542
Oct. 4, 2016 (KR) 10-2016-0127543

(51) Int. Cl. H04L 29/06; H04N 21/234; H04N 21/44; H04N 21/2343; H04N 21/4402; H04N 21/845

(52) U.S. Cl. CPC H04L 65/602; H04L 65/4069; H04N 21/23406; H04N 21/8456; H04N 21/234345; H04N 21/440245; H04N 21/44004

(57) ABSTRACT

Provided is a video processing apparatus including a communication unit configured to receive a video file from a server, a data processor configured to divide the video file into a plurality of pieces of video data and generate instructions for playing the plurality of pieces of video data, a channel manager configured to generate channels equal in number to the plurality of pieces of video data, classify the instructions generated by the data processor on a per-channel basis, and store the classified instructions in the channels, and a graphic processor configured to identify the instructions stored in the channels on a per-channel basis and sequentially execute the instructions on a per-channel basis.

### CROSS-REFERENCE TO RELATED APPLICATIONS

This application claims the benefit of priority of Korean Patent Application No. 10-2016-0127542, filed on Oct. 4, 2016, and Korean Patent Application No. 10-2016-0127543, filed on Oct. 4, 2016, in the Korean Intellectual Property Office, the disclosures of which are incorporated herein in their entireties by reference.

### BACKGROUND

### 1. Field

One or more embodiments relate to a video processing apparatus and method.

### 2. Description of the Related Art

Mobile devices provide several additional functions such as a camera function, in addition to a voice call function and a wireless Internet service function. A mobile device having a camera function is provided with a camera module for photographing a subject to capture an image desired by a user and store the captured image anywhere at any time.

### SUMMARY

One or more embodiments include a video processing apparatus and method which may perform control to output one piece of video data while playing a plurality of pieces of video data captured through a plurality of imaging apparatuses.

One or more embodiments include a video processing apparatus and method which may generate channels for independently processing a plurality of pieces of video data and manage a frame buffer used to perform outputting separately from the channels.

One or more embodiments include a video processing apparatus and method which may perform control to prevent a temporal delay between a plurality of pieces of video data played through a plurality of channels.

Additional aspects will be set forth in part in the description which follows and, in part, will be apparent from the description, or may be learned by practice of the presented embodiments.

According to one or more embodiments, a video processing apparatus includes a communication unit configured to receive a video file from a server; a data processor configured to divide the video file into a plurality of video data and generate instructions corresponding to the plurality of video data and the function for the plurality of video data; a channel manager configured to generate at least one channels corresponding to the plurality of video data, and store the instructions in the desirable channels; and a graphic processor configured to sequentially execute the instructions in accordance with a predetermined rule.

According to one or more embodiments, a video processing method, which is performed by a video processing apparatus, includes: receiving a video file from a server; dividing the video file into a plurality of video data and generating instructions corresponding to the plurality of video data and the function for the plurality of video data; generating at least one channels corresponding to the plurality of video data, and store the instructions in the desirable channels; and sequentially executing the instructions in accordance with a predetermined rule.

A computer program according to an embodiment of the present invention may be stored in a medium in order to use a computer to execute any one of the video processing methods according to an embodiment of the present invention.

In addition, there are also provided other methods and systems for carrying out the present invention and a computer-readable recording medium storing computer programs for executing the methods.

Additional aspects, features, and advantages other than those described above will be obvious from the following drawings, claims, and detailed description.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram showing a structure of a video processing system according to embodiments of the present invention;

FIG. 2 is a block diagram showing a structure of a video processing apparatus according to embodiments of the present invention;

FIGS. 3 and 4 are flowcharts of video processing methods according to embodiments of the present invention;

FIG. 5 shows diagrams for describing instructions generated by a video processing apparatus and a process of executing the instructions;

FIG. 6 shows diagrams for describing a process of executing instructions stored in a first channel and a second channel generated by a video processing apparatus;

FIG. 7 is a diagram for describing an example in which a video file obtained through three imaging apparatuses is played;

FIG. 8 is a diagram for describing a process of processing three pieces of video data obtained by capturing one object;

FIG. 9 is a diagram for describing a video processing method according to embodiments of the present invention; and

FIG. 10 is a block diagram showing a structure of a video processing apparatus according to embodiments of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are described below, by referring to the figures, to merely explain aspects of the present description. As used herein, the term “and/or” includes any and all combinations of one or more of the associated listed items. Expressions such as “at least one of,” when preceding a list of elements, modify the entire list of elements and do not modify the individual elements of the list.

While the invention is susceptible to various modifications and alternative forms, exemplary embodiments thereof are shown by way of examples in the drawings and will herein be described in detail. Advantages and features of the present invention, and implementation methods thereof will be clarified through following embodiments described with reference to the accompanying drawings. However, the present invention is not limited to the following embodiments and may be implemented in various forms.

Hereinafter, preferred embodiments of the present invention will be described in detail with reference to the accompanying drawings, and the same or similar elements are designated with the same numeral references regardless of the numerals in the drawings, and their redundant description will be omitted.

It will be understood that although the terms “first,” “second,” etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

When a certain embodiment may be implemented differently, a specific process order may be performed differently from the described order. For example, two consecutively described processes may be performed substantially at the same time or performed in order opposite to the described order.

In the following embodiments, a “circuit” may include, for example, a hard-wired circuit, a programmable circuit, a state machine circuit, and/or firmware that store instructions executable by a programmable circuit, and a combination thereof. An application may be implemented as code or instructions that are executable on a host processor or other programmable circuits. As used in an embodiment of the present invention, a module may be implemented as a circuit. A circuit may be implemented as an integrated circuit, such as an integrated circuit chip.

Furthermore, when one part is referred to as “comprising (or including or having)” other elements, it should be understood that it can comprise (or include or have) only those elements, or other elements as well as those elements unless specifically described otherwise. Moreover, terms such as “unit,” “part,” and “module” described in the specification refer to an element for performing at least one function or operation and may be implemented in hardware, software, or a combination of hardware and software.

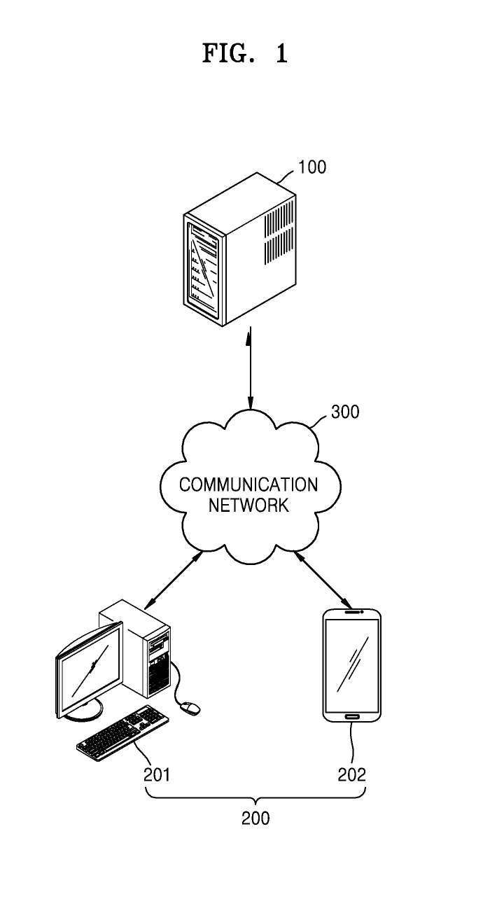

FIG. 1 is a diagram showing a video processing system 10 according to an embodiment of the present invention.

Referring to FIG. 1, the video processing system 10 according to an embodiment of the present invention may include a server 100, a plurality of video processing apparatuses 200, and a communication network 300.

The server 100 performs a function of storing and managing video files registered by a user and transmitting a predetermined video file upon the user's request.

The user accesses the server 100 through each of the video processing apparatuses 200 and downloads and plays a video file. Also, the user may capture a video with the video processing apparatus 200. The video captured by the user may be uploaded to the server 100 and shared with other users. In this case, the video file may include a plurality of video files obtained by capturing any object at various angles or include a 360 degree image captured by the user.

Each of the plurality of video processing apparatuses 200 may refer to a communication terminal that may use a web service in a wired or wireless communication environment. Here, the video processing apparatus 200 may be a personal computer 201 of the user or a mobile terminal 202 of the user.

In more detail, the video processing apparatus 200 may include, but is not limited to, a computer (e.g., a desktop, a laptop, a tablet, etc.), a media computing platform (e.g., a cable, a satellite set-top box, and a digital video recorder), a handheld computing apparatus (e.g., a personal digital assistant (PDA), an email client, etc.), any type of cell phone, or any type of computing or communication platform.

The communication network 300 serves to connect the plurality of video processing apparatuses 200 with the server 100. That is, the communication network 300 refers to a communication network that provides a connection path through which the video processing apparatuses 200 may connect to the server 100 and then transmit or receive data. For example, the communication network 300 may include, but is not limited to, wired networks such as local area networks (LANs), wide area networks (WANs), metropolitan area networks (MANs), and integrated services digital networks (ISDNs) or wireless networks such as wireless LANs, CDMA, Bluetooth, and satellite communication.

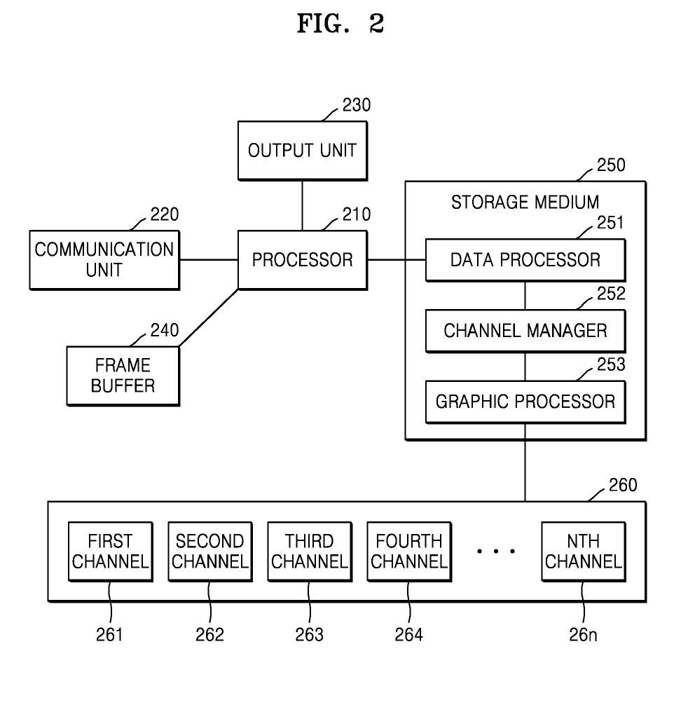

FIG. 2 is a block diagram showing a structure of the video processing apparatus 200 according to embodiments of the present invention.

Referring to FIG. 2, the video processing apparatuses 200 may include a processor 210, a communication unit 220, an output unit 230, a frame buffer 240, a storage medium 250, and a channel storage 260.

The video processing apparatus 200 according to embodiments of the present invention may play a video file obtained through a general capture and also play a video file including a plurality pieces of video data obtained with a plurality of imaging apparatuses. In particular, the video processing apparatus 200 may perform processing to prevent a pause or delay of an output or play due to a lack of resources caused by outputting a plurality of pieces of video data at the same time at which the video data is decoded. The video processing apparatus 200 generates independent channels for playing each piece of the video data in order to appropriately distribute resources of a processor to process a video. Also, the video processing apparatus 200 may store the generated channels in separate areas and may store and manage a fence value used to execute instructions between the channels independently and synchronously.

Typically, the processor 210 controls the overall operation of the video processing apparatus 200. For example, the processor 210 may perform control to execute the communication unit 220, the output unit 230, the frame buffer 240, the storage medium 250, and the channel storage 260, as well as control software installed in the storage medium 250.

For example, the processor 210 may refer to a data processing apparatus that is built in hardware and has a circuit physically structured to perform a function expressed in code or instructions included in a program. For example, the data processing apparatus built in hardware may include, but is not limited to, a microprocessor, a central processor (CPU), a processor core, a multiprocessor, an application-specific integrated circuit (ASIC), a field programmable gate array (FPGA), etc. The processor 210 may render input data and provide the input data to the output unit 230.

The communication unit 220 may be an apparatus including hardware and software needed to transmit and receive signals such as a control signal or a data signal through wired/wireless connection with another network apparatus.

The output unit 230 outputs information processed by the video processing apparatus 200. In particular, the output unit 230 may be connected with the frame buffer 240 and configured to output data stored in the frame buffer 240 without change. It will be appreciated that control is performed such that the data output by the output unit 230 is not changed while the data is stored in the frame buffer 240. The frame buffer 240 may be managed with a synchronization signal generated periodically. That is, the output unit 230 updates the output whenever the synchronization signal is generated. Also, when second data begins to be stored in the frame buffer 240 while first data is being stored in the frame buffer 240, the output unit 230 still outputs the first data until the second data is completely stored in the frame buffer 240, and then starts to output the second data.

Also, the output unit 230 may be driven in such a way that only a changed area is updated. When the second data begins to be stored in the frame buffer 240 while the first data is being stored in the frame buffer 240, the output unit 230 may be driven to compare the first data and the second data, extract an area with a difference between the output values, and update only the area with the difference. Through a comparison with data prestored in the frame buffer 240, the output unit 230 updates the entire area when the change of data is achieved over the entire area and updates only a portion of the area, when the change of data is achieved in the portion of the area.

When the output unit 230 is configured as a touch screen by forming a layered structure together with a touchpad, the output unit 230 may be used as an input apparatus as well as an output apparatus. The output unit 230 may include at least one of a liquid crystal display (LCD), a thin film transistor-LCD (TFT-LCD), an organic light emitting diode (OLED) display, a flexible display, a three-dimensional (3D) display, and an electrophoretic display. Also, the video processing apparatus 200 may include two or more output units 230 according to the implementation of the video processing apparatus 200. In this case, the two or more output units 230 may be disposed to face each other using a hinge.

The frame buffer 240 has a data size according to a pixel number (ppi) and a per-pixel resolution. The frame buffer 240 may be electrically connected with the output unit 230 and configured to allow input data to be output.

The storage medium 250 refers to a storage apparatus that is included in the video processing apparatus 200 or electrically connected with the video processing apparatus 200. The storage medium 250 may store a plurality of modules for operating the video processing apparatus 200. The storage medium 250 may allow various applications (e.g., a game application, a web browser, a messenger application, a shopping application, a social network service application, etc.) installed in the video processing apparatus 200 to be driven.

The storage medium 250 may include at least one of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Also, the video processing apparatus 200 may operate a web storage or a cloud server that performs a storage function of the storage medium 250 over the Internet.

The storage medium 250 may include a data processor 251, a channel manager 252, and a graphic processor 253.

The data processor 251 is configured to play a video file received through the communication unit 220. The data processor 251 analyzes the video file received through the communication unit 220 and divides the video file into a plurality of pieces of video data. The data processor 251 has the function that plays the video data and synchronizes the plurality of video data. The data processor 251 generates instructions for playing the plurality of pieces of video data. In this case, when the video data includes virtual reality and a 360 degree video as a result of analyzing the video data, control is performed such that instructions for playing the virtual reality or 360 degree video are generated. The data processor 251 may generate a synchronization instruction at certain intervals to synchronize and play the plurality of pieces of video data. The synchronization instructions generated by the data processor 251 may be stored between the data play instructions. The synchronization instructions stored in each channel have certain intervals. The synchronization instructions may be associated with a predetermined fence value in order not to cause a difference in time between pieces of data played through the plurality of channels. Here, the predetermined interval is set as a somewhat short time, such as 1 second, 5 seconds, etc., by a manager. For example, the instructions stored in each channel may further include an instruction for reading a fence value at certain intervals (e.g., SYNC( )) and an instruction for changing the fence value to a predetermined value (e.g., SET( )) in addition to an instruction for playing video data.

Also, the data processor 251 is configured to synchronize and play a plurality of pieces of video data obtained by capturing an object included in the video file from a plurality of viewpoints. Here, the object refers to a person, a thing, a living thing, etc. which are included in a video file or video data. As a result, the data processor 251 may be configured to play the plurality of pieces of video data at the same time and may be configured to synchronize and play the plurality of pieces of video data.

In order to play the video file on a per-viewpoint basis, the channel manager 252 generates channels equal in number to the plurality of pieces of video data obtained by dividing the video file and then divides and stores the instructions generated by the data processor 251 on a per-channel basis.

The graphic processor 253 is configured to divide the instructions stored in the channels on a per-channel basis and sequentially execute the instructions on a per-channel basis.

The graphic processor 253 executes instructions stored in all or some of the generated channels irrespective of a channel output through the output unit 230. In this case, the graphic processor 253 executes instructions stored in a first channel independently of instructions stored in the other channels. The channels are stored in different areas, and a processor may allocate different resources to each of the channels. While the instructions stored in the first channel are executed, the instructions stored in the other channels are not executed. When an instruction configured to set a fence value stored in the first channel to a different value is executed, the graphic processor 253 is configured to stop executing the first channel and process the instructions stored in the channels other than the first channel.

For example, when a video file is played using a first channel and a second channel, the graphic processor 253 stores and manages fence values for the first channel and the second channel. First, the graphic processor 253 selects any one of the two channels, that is, the first channel. The graphic processor 253 reads the fence value for the first channel in order to execute the instructions stored in the first channel, which is selected. In this case, when the fence value read from one of the first channel and the second channel is less than or equal to the current state (less than a representative fence value), the graphic processor 253 is controlled to execute instructions stored in the corresponding channel. That is, the graphic processor 253 stops executing instructions stored in another channel and executes the instructions stored in the corresponding channel. When the execution of the instructions stored in the first channel is completed, the graphic processor 253 may change a state of the first channel to the current state. Each channel state is determined by a fence value for each channel. The current state is determined by fence values of channels that are synchronously executed. In detail, the current state is determined as the smaller value between the fence value for the first channel and the fence value for the second channel. Alternatively, the current state may be determined as a representative fence value. The fence value corresponding to the current state may be separately stored.

In order to separately play a plurality of pieces of video data included in one video file, the channel storage 260 generates a plurality of channels corresponding to the plurality of pieces of video data. The plurality of channels 261, 262, 263, 264, . . . , 26n are stored in areas of the channel storage 260 that are logically separated from one another. The plurality of channels 261, 262, 263, 264, . . . , 26n are stored in some areas which are separated logically. The plurality of channels may not be associated with each other. In other words, when the instructions in the first channel are processed and an instruction corresponding to a channel switch event is occurred, instructions in other channels are processed in order by the instruction. When switched the channels, an instruction which have executed in the first channel is deleted or moved to other channels. The plurality of channels are accessed at the same time by the generated event, or thread.

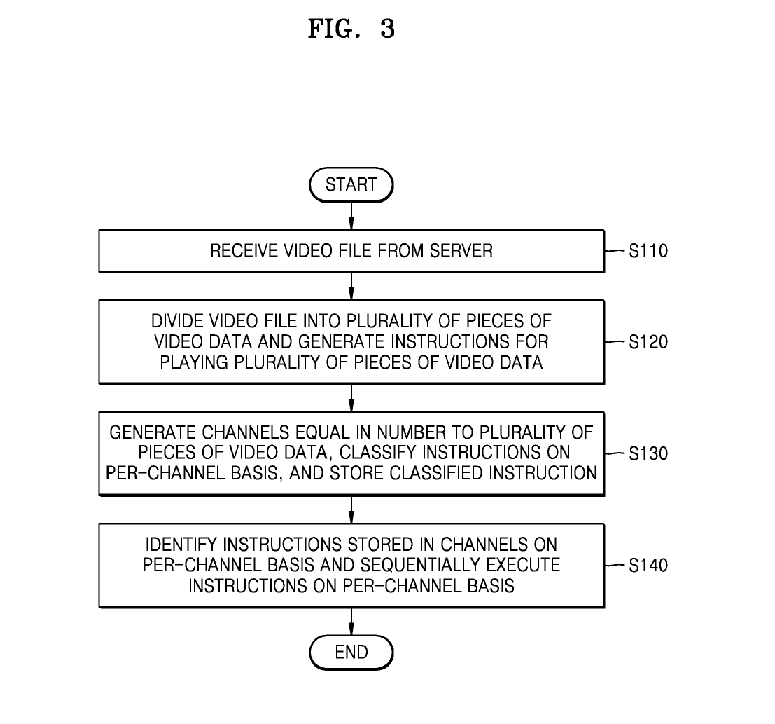

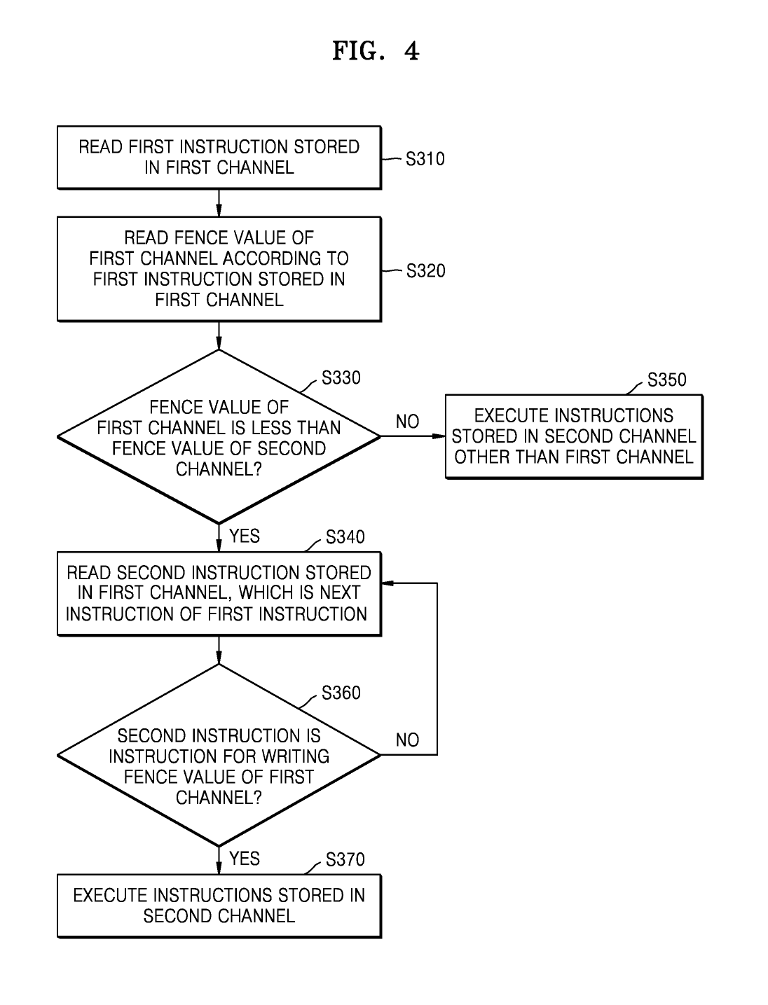

FIGS. 3 and 4 are flowcharts of video processing methods according to embodiments of the present invention.

Referring to FIG. 3, a video processing method according to an embodiment of the present invention may include receiving a video file (S110), processing the video file (S120), generating channels and classifying instructions on a per-channel basis (S130), and processing the instructions (S140).

In S110, the video processing apparatus 200 receives a video file that is selected by a user or shared with another user.

In S120, the video processing apparatus 200 is configured to play the video file received through the communication unit 220. The video processing apparatus 200 analyzes the video file received through the communication unit 220 and divides the video file into a plurality of pieces of video data. The video processing apparatus 200 generates instructions for playing the plurality of pieces of video data. The video processing apparatus 200 may add a synchronization instruction to synchronize and play the plurality of pieces of video data. The synchronization instruction is added at certain intervals in consideration of a unit for playing video data. Here, the predetermined interval is set as a somewhat short time, such as 1 second, 5 seconds, etc., by a manager. The synchronization instruction is an instruction for preventing a difference in time between a plurality of pieces of data played through the plurality of channels from occurring. In detail, the synchronization instruction may be generated using a predetermined fence value. For example, the instructions stored in each channel may further include a synchronization instruction or instructions for reading a fence value (e.g., SYNC( )) and changing the fence value to a predetermined value (e.g., SET( )) at certain intervals, in addition to an instruction for playing video data. In S120, an operation of the data processor 251 may be performed.

In S130, in order to play the video file on a per-viewpoint basis, the video processing apparatus 200 generates channels equal in number to the plurality of pieces of video data obtained by dividing the video file and then divides and stores the instructions generated by the data processor 251 on a per-channel basis.

In S140, the video processing apparatus 200 is configured to divide the instructions stored in the channels on a per-channel basis and sequentially execute the instructions on a per-channel basis.

The video processing apparatus 200 executes instructions stored in all or some of the generated channels, irrespective of a channel output through the output unit 230. In this case, the video processing apparatus 200 executes instructions stored in a first channel independently of instructions stored in the other channels. While the instructions stored in the first channel are executed, the instructions stored in the other channels are not executed. When an instruction configured to set a fence value stored in the first channel to a different value is executed, the video processing apparatus 200 is configured to process the instructions stored in the channels other than the first channel.

Referring to FIG. 4, a video processing method according to an embodiment of the present invention may include reading a first instruction stored in a first channel (S310), reading a fence value of the first channel according to a first instruction stored in the first channel (S320), determining whether the fence value of the first channel is less than a fence value of a second channel (S330), reading a second instruction stored in the first channel, which is the next instruction of the first instruction (S340), executing instructions stored in the second channel rather than the first channel (S350), determining whether the second instruction is an instruction for writing the fence value of the first channel (S360), and executing instructions stored in the second channel (S370).

In S310, the video processing apparatus 200 reads and executes a first instruction stored in a first channel. Generally, the video processing apparatus 200 processes instructions stored in each channel in the order in which the instructions were stored. In particular, the video processing apparatus 200 determines a channel to be executed in the order in which channels should be played. This may also be determined by a fence value. That is, when a fence value of any channel does not exceed a representative fence value, instructions stored in the channel should be processed.

In S320, the video processing apparatus 200 reads a fence value of a first channel according to a first instruction (sync) stored in the first channel.

In S330, the video processing apparatus 200 determines whether the fence value of the first channel is less than a fence value of a second channel. In this case, the video processing apparatus 200 may also determine whether the fence value of the first channel is less than the representative fence value in addition to the fence value of the second channel.

In S340, when it is determined that the fence value of the first channel is less than the fence value of the second channel, the video processing apparatus 200 reads a second instruction stored in the first channel, which is the next instruction of the first instruction.

In S350, when it is determined that the fence value of the first channel is not less than the fence value of the second channel, the video processing apparatus 200 executes instructions stored in the second channel rather than the first channel.

In S360, the video processing apparatus 200 determines whether the second instruction is an instruction for writing the fence value of the first channel. When it is determined that the second instruction is not an instruction for writing the fence value of the first channel, the video processing apparatus 200 reads and executes the next instruction.

In S370, when the second instruction is an instruction for writing the fence value of the first channel, the video processing apparatus 200 moves to a channel other than the first channel and executes the instructions.

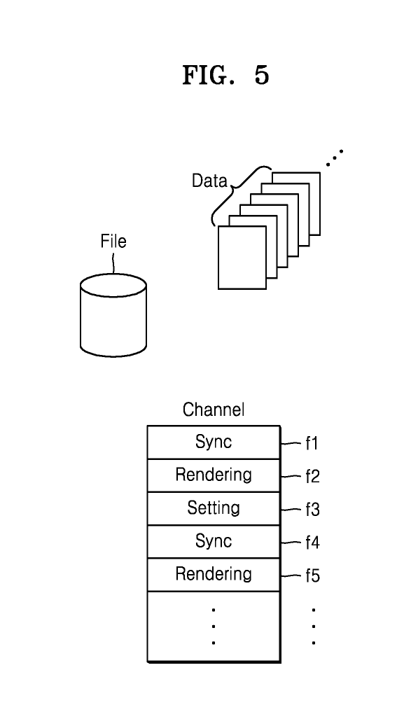

FIG. 5 shows diagrams for describing instructions generated by the video processing apparatus 200 and a process of executing the instructions.

As shown in FIG. 5, the video processing apparatus 200 receives a video file from the server 100. In this case, the video file is received from the server 100 through a network transmission medium and then stored in a storage medium of the video processing apparatus 200. The video processing apparatus 200 analyzes the received video file. First, the video processing apparatus 200 may analyze the video file in consideration of a file format of the video file and extract a plurality of pieces of video data included in the video file on the basis of a result of the analysis.

A video file registered in the server 100 may include a set of still images or video data obtained by capturing one object at one or more angles, from one or more viewpoints, and in one or more directions. The video processing apparatus 200 may edit the plurality of pieces of video data, focusing on the object included in the plurality of pieces of video data, in addition to extracting the plurality of pieces of video data from the video file. According to an embodiment of the present invention, images obtained by capturing one object at various angles may be extracted and played through the plurality of pieces of video data. In this case, the video processing apparatus 200 may edit a video, focusing on a certain object included in the video, so that the object included in the video may be identically recognized by every user. The video may be edited such that the object included in the video is located at the same distance, in the same color, in the same place, etc.

The video processing apparatus 200 may generate a plurality of channels corresponding to the plurality of pieces of video data. In this case, each of the channels corresponding to the plurality of pieces of video data stores instructions f1, f2, f3, f4, f5, . . . for outputting or playing the video data. The video processing apparatus 200 may further generate instructions f1 and f3 for synchronizing the plurality of pieces of video data and add the generated instructions to the channel, in addition to an instruction f2 (rendering) for playing the video data. Also, the instructions stored in the channel are played on the basis of one unit for output. Here, the unit for output is determined as a function f1 (sync) for reading a fence value and a function f3 (setting) for writing the fence value as a certain value. That is, the unit for output ranges from f1 to f3. An output time of one unit for output may be predetermined and constantly maintained.

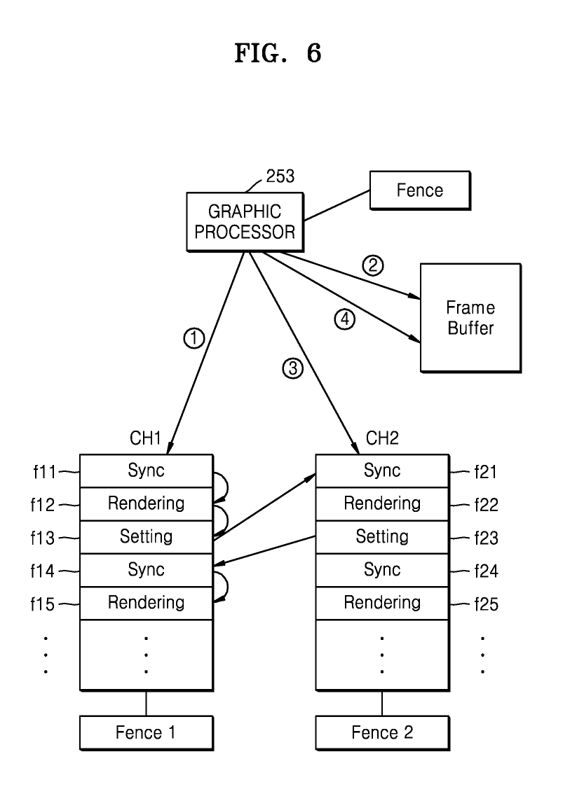

FIG. 6 shows diagrams for describing a process of executing instructions stored in a first channel and a second channel generated by the video processing apparatus 200.

As shown in FIG. 6, the video processing apparatus 200 may extract two pieces of video data on the basis of a predetermined index included in a video file. In this case, the video processing apparatus 200 generates a first channel CH1 and a second channel CH2 for playing the two pieces of video data, generates instructions for playing the video data, and stores the instructions in respective channels.

The graphic processor 253 stores and manages a representative fence value for playing a video file. An initial value of the representative fence value may be set to be zero, which is a predetermined value. Similarly, an initial value of a fence value of each channel may be zero.

The graphic processor 253 approaches one of the generated channels and reads instructions. That is, the graphic processor 253 approaches the first channel CH1 that satisfies a predetermined condition and reads instructions. As shown in FIG. 6, the graphic processor 253 reads a fence value of the first channel (fence 1) by a function for reading a fence value f11 (sync). When the fence value of the first channel (fence 1) does not exceed the representative fence value, it is determined that additional instructions need to be executed for synchronization with another channel. Thus, the graphic processor 253 executes the next instructions of the first channel. When the fence value of the first channel (fence 1) exceeds the representative fence value, additional instructions need not be executed for synchronization with another channel. Thus, the graphic processor 253 moves to another channel.

The graphic processor 253 executes a play function f12 (rendering) subsequent to f11. Thus, a portion of the video data corresponding to the first channel is played. By executing f12, data to be output to a frame buffer (frame buff) may be input. The graphic processor 253 executes f13 (setting) subsequent to f12. Setting is a function for setting the fence value of the first channel (fence 1) to a different value. The fence value is changed from 0 to 1.

The graphic processor 253 is configured to search for a channel having a fence value that does not exceed the representative fence value among the generated channels and execute the channel. That is, the graphic processor 253 approaches the second channel CH2 after the first channel CH1 and executes instructions stored in the second channel CH2. In the same way as the first channel, the graphic processor 253 sequentially executes a function f21 for reading a fence value, a function f22 for playing video data, and a function f23 for setting the fence value to a different value. By executing f22, data to be output may be input to a frame buffer (frame buff). When f23 is executed by the graphic processor 253, the fence value of the second channel (fence 2) is set to 1.

When fence values of all the channels are finally changed, the graphic processor 253 also sets the representative fence value to 1, which is equal to the fence values of the channels.

Also, the frame buffer (frame buff) may be set such that only a result of one channel selected by a user or a manager is input. Thus, since a plurality of pieces of video data is played or executed at the same speed, any one piece of video data may be output. Also, when an output signal of another piece of video data is input by a user, the video data is output directly without delay because the video data has already been played or executed in another channel, irrespective of the output.

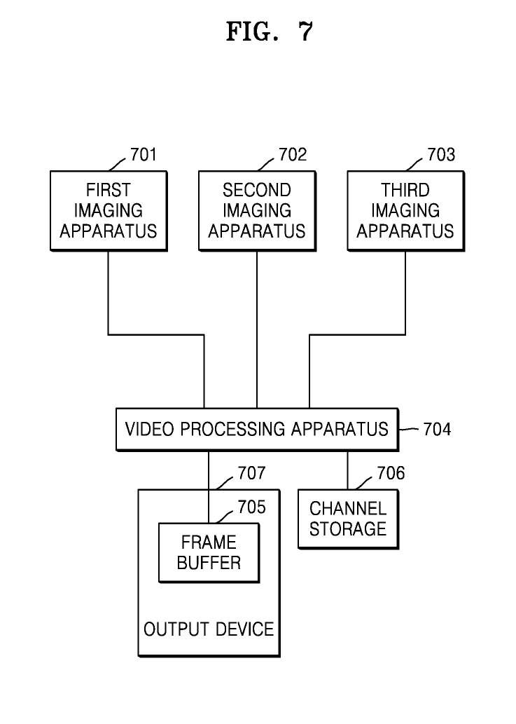

FIG. 7 is a diagram for describing an example in which a video file obtained through three imaging apparatuses is played.

As shown in FIG. 7, a video processing apparatus 704 may generate one video file including video data obtained through three imaging apparatuses 701, 702, and 703 connected electrically or connected over a communication network. FIG. 7 shows three imaging apparatuses. However, the number of imaging apparatuses is not limited thereto. The video processing apparatus 704 is electrically connected with the output apparatus 707 to output the video data. In this case, the output apparatus 707 has a frame buffer for temporarily storing data to be output and is configured to output data input to the frame buffer. While data is being input to the frame buffer or while data that was input is deleted, control is performed such that the output apparatus 707 is not updated. This is to prevent an afterimage and a blurring of the output apparatus 707. Also, the video processing apparatus 704 has a separate channel storage 706 and is configured to generate channels equal in number to the plurality of pieces of video data individually obtained and play the plurality of pieces of video data individually through the generated channels.

Thus, the video processing apparatus 704 may allow any one piece of video data to be output while processing the plurality of pieces of video data. In this case, the output data is any one of the plurality of pieces of data captured and may vary depending on an input from a user or a signal from an imaging apparatus. In order to output any one piece of video data without delay, the video processing apparatus 704 synchronizes and plays a plurality of pieces of video data through the channels, irrespective of the output. The imaging apparatuses 701, 702, and 703 may group still images that have been captured to generate one piece of video data. A separate synchronization process is not needed because still images are captured. The still images are synchronized in such a way that time intervals, that is, frame rates are set to be the same.

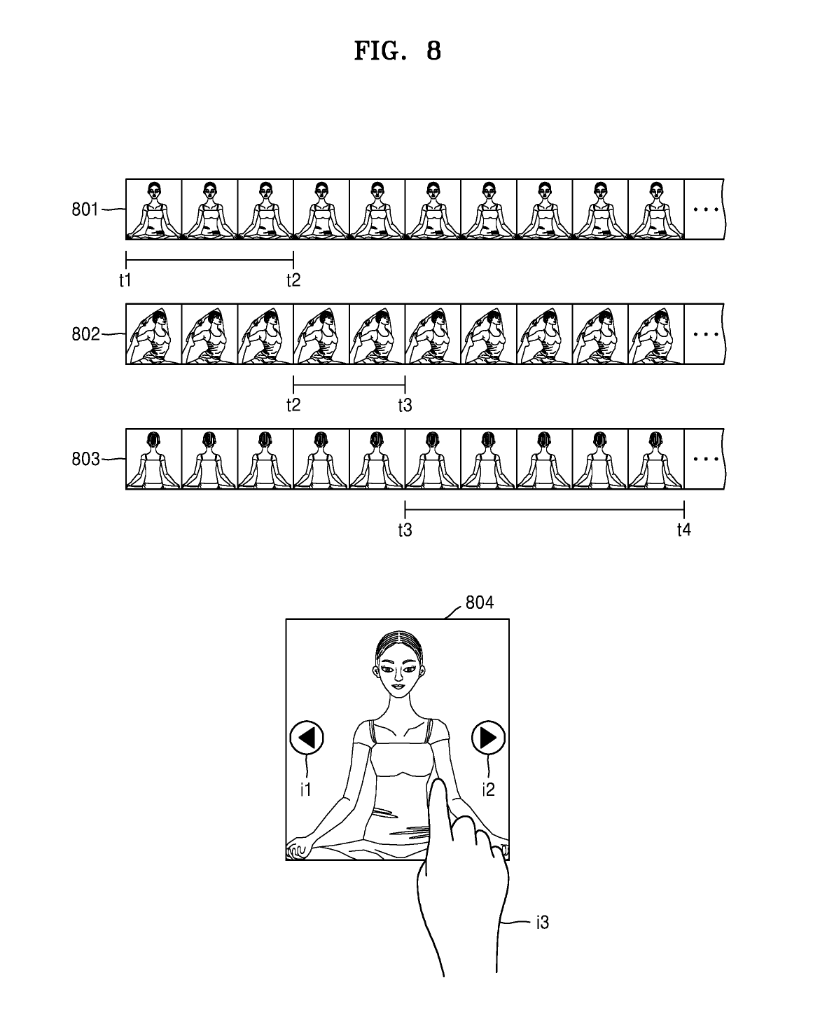

FIG. 8 is a diagram for describing a process of processing three pieces of video data obtained by capturing one object.

As shown in FIG. 8, a video processing apparatus according to an embodiment of the present invention extracts, from one video file, first video data obtained by capturing the front of a person, second video data obtained by capturing the side of a person, and third video data obtained by capturing the back of a person and generates channels corresponding to the first, second, and third video data.

The video processing apparatus generates channels for playing or processing the first, second, and third video data 801, 802, and 803 and plays the first, second, and third video data 801, 802, and 803 through the channels.

In this case, the video processing apparatus arbitrarily sets one of the first, second, and third video data and outputs the set video data through an output unit. A user interface 804 that is output further includes icons i1 and i2 for converting output data, in addition to at least one of the first, second, and third video data. Data that is output as a selection input for the output icons i1 and i2 is changed into one of the first, second, and third video data.

Also, the video processing apparatus may output the first video data at first and then change data to be output according to a user input i3 to the output unit. Generally, the direction, area, resolution, size, etc. of video data to be output according to a user input are changed. However, the present invention is characterized in that a change to other video data is enabled.

Conventionally, in order to output other video data, a selection input for outputting other video data needs to be input. However, the present invention is implemented such that video data obtained by other imaging apparatuses is generated as one file and conversion between a plurality of pieces of video data obtained while the file is played is enabled.

Also, the video processing apparatus may change the video data played according to a user input. For example, the first video data 801 may be output from t1 to t2. The second video data 802 may be output from t2 to t3. Finally, the third video data 803 may be played from t3 to t4 according to a user input that is input at t3. In this case, the video data output through the video processing apparatus may be changed according to a user input, entered when the video data is played or a user input, entered when the video data is captured.

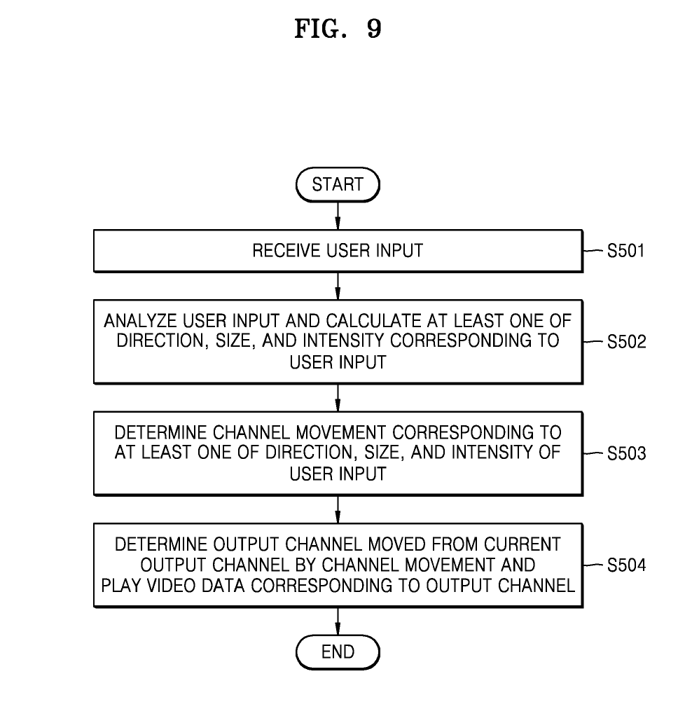

FIG. 9 is a diagram for describing a video processing method according to embodiments of the present invention.

The video processing method according to embodiments of the present invention may further include receiving a user input (S510), analyzing the user input and calculating at least one of a direction, a size, and an intensity corresponding to the user input (S520), determining channel movement corresponding to at least one of a direction, a size, and an intensity of the user input (S530), and determining an output channel that is moved from a channel being output by the channel movement and playing video data corresponding to the output channel (S540).

In S510, the video processing apparatus 200 receives a user input from a user.

In S520, the video processing apparatus 200 analyzes the user input and calculates at least one of a direction, a size, and an intensity corresponding to the user input. Since an operation in S520 is the same as an operation of the input controller 420, a detailed description thereof will be omitted.

In S530, the video processing apparatus 200 generates an event corresponding to channel movement corresponding to at least one of the direction, the size, and the intensity of the user input.

In S540, the video processing apparatus 200 determines an output channel that is moved by the channel movement from a channel being output and plays video data corresponding to the output channel. In response to the user input, the video data output through the output unit is changed. The video processing apparatus 200 may change an output image by changing a source of data input to a frame buffer.

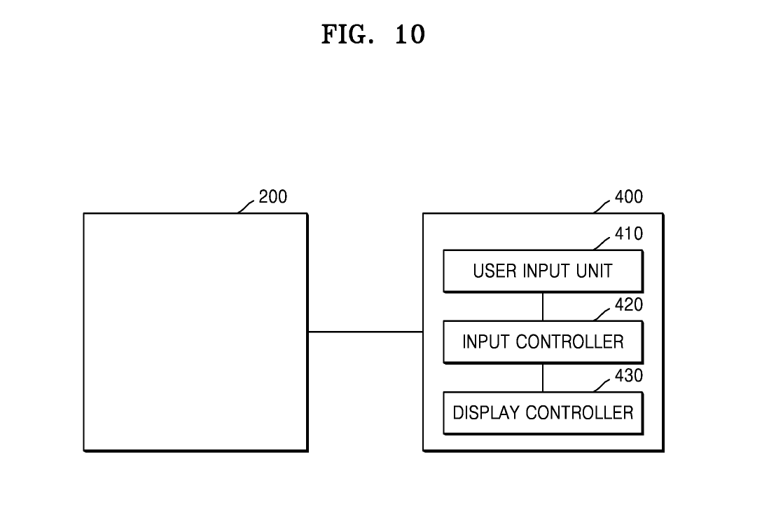

As shown in FIG. 10, the video processing apparatus 200 according to embodiments of the present invention is electrically connected with an output control module 400. The output control module 400 may include a user input unit 410, an input controller 420, and an output controller 430.

The user input unit 410 refers to a unit for receiving an event or data from a user as an input. For example, the user input unit 410 may include, but is not limited to, a key pad, a dome switch, a touchpad (a contact capacitance type, a pressure resistance type, an infrared sensing type, a surface ultrasonic wave conduction type, an integral tension measurement type, a piezoelectric effect type, etc.), a jog wheel, a jog switch, etc.

The user input unit 410 may acquire a user input. For example, the user input unit 410 may acquire a touch input including a user event, a scroll input, a directional-key input, and a motion in a predetermined direction with respect to an output video.

The input controller 420 may analyze the direction, duration, intensity, etc. of the user input acquired through the user input unit 410 and may output a channel movement event corresponding to the user input. For example, when a user input corresponding to a predetermined first stage channel movement is received, the input controller 420 generates a channel movement event corresponding to the first stage channel movement and transmits the channel movement event to the graphic processor 253. Thus, the graphic processor 253 performs control such that video data is output through a channel moved through the output controller 430. The graphic processor 253 may change a channel for the video data that is output while a channel connected with the frame buffer is moved. When a predetermined user input corresponding to an output of all the video data is received, the input controller 420 may perform control such that a plurality of pieces of video data extracted from the video file are output. In this case, in order to output the plurality of pieces of video data, the output unit 230 may be divided depending on the number of pieces of video data.

The output controller 430 performs control such that a video may be provided through the output unit 230 of the video processing apparatus 200. In particular, in response to the user input, the output controller 430 may output first video data played through a first channel and then may output second video data played through a second channel. In order to change video data being output, the output controller 430 may stop playing current video data and play requested video data. Unlike this, the video processing apparatus according to embodiments of the present invention performs control such that any one piece of video data selected by a user is output while a plurality of pieces of video data is being played. That is, the video processing apparatus may output new video data without needing to stop playing the current video data.

The output controller 430 determines an output channel according to the channel movement event and performs control such that video data played or rendered through the output channel is output. The output controller 430 may be implemented to determine an output channel according to the channel movement event and deliver output data of the output channel to the frame buffer. That is, the output controller 430 transmits the video data played through the output channel to the frame buffer.

The output controller 430 may create an animation effect in which ring-shaped virtual output screens seems to be moved according to a user input. The output controller 430 may also be implemented such that the pieces of video data played by the channels in a virtual space are disposed in the shape of a circle with respect to a predetermined reference point. The output controller 430 may change video data positioned in front of a predetermined reference position according to a user input. When the first to third video data should move, this should be implemented in such a way that the first video data was positioned in front, the second video data is moved to the front, and then the third video data is moved to the front. That is, the video data may be changed in a rotating way. A rotational direction may be from left to right or from top to bottom. A rotational angle and a rotational speed may be determined according to the direction, intensity, and duration of the user input. The duration of the user input may be proportional to movement information. Even when there are lower and upper limits of the duration, and the duration exceeds the upper limit, a user input having a certain upper threshold duration is generated.

The output controller 430 may output a plurality of videos such that the videos partially overlap one another. That is, when the videos partially overlap one another, the overlapping parts may be blurred. Thus, the plurality of pieces of video data may be represented as one video.

Also, the output controller 430 may output still images at certain intervals. The output controller 430 may show the still images as a video though the still images are output.

The video processing apparatus and method according to embodiments of the present invention may perform control to output one piece of video data while playing a plurality of pieces of video data captured through a plurality of imaging apparatuses.

Also, the video processing apparatus and method according to embodiments of the present invention may generate channels for independently processing a plurality of pieces of video data and manage a frame buffer that is used to perform outputting separately from the channels.

Also, the video processing apparatus and method according to embodiments of the present invention may perform control to prevent a temporal delay between a plurality of pieces of video data played through a plurality of channels.

The above-described embodiments of the present invention may be implemented in the form of a program instruction that is executable through various computer components and recordable on a computer-readable medium. Examples of the computer-readable recording medium include a magnetic medium such as a hard disk, a floppy disk, or a magnetic tape, an optical medium such as a compact disc-read only memory (CD-ROM) or a digital versatile disc (DVD), a magneto-optical medium such as a floptical disk, and a hardware device such as a ROM, a RAM, or a flash memory that is specially designed to store and execute program instructions.

The computer program may be designed and configured specially for the exemplary embodiments or be known and available to those skilled in computer software. Examples of the computer program include a high-level language code executable by a computer with an interpreter, in addition to a machine language code made by a compiler.

The particular implementations shown and described herein are illustrative examples of the invention and are not intended to otherwise limit the scope of the invention in any way. For the sake of brevity, conventional electronics, control systems, software development and other functional aspects of the systems may not be described in detail. Furthermore, the connecting lines, or connectors shown in various figures presented are intended to represent exemplary functional relationships, physical connections or logical couplings between the various elements. It should be noted that many alternative or additional functional relationships, physical connections or logical connections may be present in a practical apparatus. Moreover, no item or component is essential to the practice of the invention unless the element is specifically described as “essential” or “critical.”

The use of the terms “a,” “an,” and “the” and similar referents in the context of the present invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein may be performed in any suitable order unless otherwise indicated herein or otherwise clearly contradicted by context. Embodiments are not limited to the described order of the steps. The use of any and all examples, or exemplary language (e.g., “such as”) provided herein, is intended merely to better illuminate embodiments and does not impose a limitation on the scope of embodiments unless otherwise claimed. Also, it will be understood by those skilled in the art that various modifications, combinations, and changes may be made to the appended claims and their equivalents according to design conditions and factors without departing from the scope of the present invention.

What is claimed is:

1. A video processing apparatus comprising:
a communication unit configured to receive a video file from a server;
a data processor configured to divide the video file into a plurality of video data and generate instructions corresponding to the plurality of video data and the function for the plurality of video data;
a channel manager configured to generate at least one channel corresponding to the plurality of video data, and store the instructions in the preset channels; and
a graphic processor configured to sequentially execute the instructions in accordance with a predetermined rule.

2. The video processing apparatus of claim 1, wherein a number of the channels is proportional to the number of the plurality of video data.

3. The video processing apparatus of claim 1, further comprising an output control module configured to, when a user input is received from a user, generate a channel movement event based on at least one of a direction, a size, and an intensity of the user input, determine an output channel corresponding to the channel movement event, and deliver output data of the output channel to a frame buffer.

4. The video processing apparatus of claim 1, wherein the graphic processor does not consider other channels while instructions stored in a first channel are executed.

5. The video processing apparatus of claim 3, wherein, when an instruction for setting a fence value of the first channel to a certain value is executed while the instructions stored in the first channel are executed, the graphic processor is configured to execute instructions of other channels.

6. The video processing apparatus of claim 4, further comprising an output unit configured to determine an output channel corresponding to the user input and output a video corresponding to the output channel.

7. The video processing apparatus of claim 1, wherein the video data is a set of still images captured at certain intervals.

8. The video processing apparatus of claim 3, wherein the instruction processor further includes a function for identifying instructions generated by the data processor based on one unit for output and checking or setting a fence value based on the unit for output.

9. A video processing method, which is performed by a video processing apparatus, the video processing method comprising:
receiving a video file from a server;
dividing the video file into a plurality of video data and generating instructions corresponding to the plurality of video data and the function for the plurality of video data;
generating at least one channel corresponding to the plurality of video data, and store the instructions in the preset channels; and
sequentially executing the instructions in accordance with a predetermined rule.

10. The video processing method of claim 9, wherein a number of the channels is proportional to the number of the plurality of video data.

11. The video processing method of claim 9, further comprising, when a user input is received from a user, generating a channel movement event based on at least one of a direction, a size, and an intensity of the user input, determining an output channel corresponding to the channel movement event, and delivering output data of the output channel to a frame buffer.

12. The video processing method of claim 9, wherein the executing of the instructions comprises not executing the instructions stored in other channels while instructions stored in a first channel are executed.

13. The video processing method of claim 11, wherein, when an instruction for setting a fence value of the first channel to a certain value is executed while the instructions stored in the first channel are executed, the executing of the instructions on a per-channel basis comprises executing instructions of other channels.

14. The video processing method of claim 9, further comprising determining an output channel corresponding to the user input and outputting video data corresponding to the output channel.

15. The video processing method of claim 9, wherein the video data is a set of still images captured at certain intervals.
